(19) United States
(12) Patent Application Publication
(10) Pub. No.: US 2026/0122309 A1
(43) Pub. Date: Apr. 30, 2026

(54) TECHNIQUES FOR JOINT AUDIO VIDEO STREAM SELECTION

(71) Applicant: NETFLIX, INC., Los Gatos, CA (US)

(72) Inventors: Shravya KUNAMALLA, San Jose, CA (US); Mark WATSON, San Francisco, CA (US)

(21) Appl. No.: 19/003,406

(22) Filed: Dec. 27, 2024

Related U.S. Application Data
(60) Provisional application No. 63/561,226, filed on Mar. 4, 2024.

(51) Int. Cl. H04N 21/437

(52) U.S. Cl. CPC H04N 21/437

(57) ABSTRACT

In various embodiments, a computer-implemented method for streaming audiovisual data associated with media titles includes generating a set of bitrate combinations associated with a media title, generating a set of quality metrics corresponding to the set of bitrate combinations based on an audio portion of the media title and a video portion of the media title, identifying a subset of bitrate combinations included in the set of bitrate combinations that reside along a convex hull that is associated with the set of bitrate combinations and the set of quality metrics, and causing an endpoint device to stream at least one of the audio portion of the media title or the video portion of the media title based on the subset of bitrate combinations.

### CROSS-REFERENCE TO RELATED APPLICATIONS

This application claims the benefit of U.S. Provisional application titled “TECHNIQUES FOR JOINT AUDIO VIDEO STREAM SELECTION,” filed on Mar. 4, 2024, and having Ser. No. 63/561,226. The subject matter of this related application is hereby incorporated herein by reference.

### BACKGROUND

### Field of the Various Embodiments

Embodiments of the present disclosure relate generally to computer science and video processing and, more specifically, to techniques for joint audio video stream selection.

### Description of the Related Art

A modern streaming service streams audiovisual data associated with media titles to endpoint devices across a network. Prior to streaming, audio data included in the media title is encoded using several different audio bitrates, and, similarly, video data included in the media title is encoded using several different video bitrates. Conventional audio or video encoding typically involves encoding audio or video, respectively, at different nominal or average bitrates in order to achieve consistent quality at different points on a rate-distortion curve. During streaming, an endpoint device requests the audio data from the streaming service at one of the several available audio bitrates and then outputs audio to a user. In like fashion, the endpoint device requests video data from the streaming service at one of the several available video bitrates and then outputs video to the user. The endpoint device generally selects a particular audio bitrate or a particular video bitrate based on the currently available network bandwidth, among other factors.

Conventional endpoint devices can allocate available network bandwidth between streaming audio data and streaming video data using several approaches. In some implementations, an endpoint device selects the audio bitrate and the video bitrate independently of one another. In other implementations, an endpoint device implements a fixed allocation of network bandwidth to divide the currently available network bandwidth between streaming the audio data and streaming the video data. In either implementation, endpoint devices can sometimes request audio data and video data with widely differing bitrates. For example, a given endpoint device could request audio data with a lower bitrate and request video data with a higher bitrate. Reconstructed audio or video data that is derived from lower bitrate audio data or lower bitrate video data, respectively, is generally perceived by users as having a lower level of quality. Conversely, reconstructed audio data or video data that is derived from higher bitrate audio data or higher bitrate video data, respectively, is generally perceived by users as having a higher level of quality. Because conventional endpoint devices can request audio data and video data with widely differing bitrates, the endpoint devices sometimes output audio data and video data to users with different levels of quality. The quality of the audio data and video data could be measured, for example, using Mean Opinion Scores on a scale of 1-5.

One drawback of the approaches to allocating available network bandwidth between streaming audio data and streaming video data described above is that outputting audio data and video data to users with different levels of quality generally leads to a poor user experience. In particular, users typically expect the quality of the audio data and video data associated with any given media title to be relatively consistent with one another throughout the course of a streaming session. Consequently, users can become dissatisfied with the overall streaming experience when the quality of the outputted audio data and video data diverge substantially from one another. As a general matter, audio data and video data with different levels of quality can lead to a lower overall perception of quality, as measured for example by Mean Opinion Scores for the streaming session. Another drawback is that approaches that implement a fixed allocation of bandwidth between streaming audio data and streaming video data cannot efficiently redistribute available bandwidth between streaming audio data and streaming video data during a streaming session. Consequently, changes in the available network bandwidth can oftentimes cause divergences in the quality levels of outputted audio data and outputted video data which, as described above, can lead to overall poor user experiences.

As the foregoing illustrates, what is needed in the art are more effective techniques for streaming audio data and video data to endpoint devices during streaming sessions.

### SUMMARY

In various embodiments, computer-implemented method for streaming audiovisual data associated with media titles includes generating a set of bitrate combinations associated with a media title, generating a set of quality metrics corresponding to the set of bitrate combinations based on an audio portion of the media title and a video portion of the media title, identifying a subset of bitrate combinations included in the set of bitrate combinations that reside along a convex hull that is associated with the set of bitrate combinations and the set of quality metrics, and causing an endpoint device to stream at least one of the audio portion of the media title or the video portion of the media title based on the subset of bitrate combinations.

At least one technical advantage of the disclosed techniques relative to the prior art is that the disclosed techniques enable endpoint devices to select combinations of audio bitrate and video bitrate that maximize a joint quality metric per bit of available bandwidth. Accordingly, for a given level of available network bandwidth, the disclosed techniques enable a given endpoint device to output audio and video to users with similar levels of quality and/or levels of quality that, in combination maximize an overall quality of experience as measured by the joint quality metric. The disclosed techniques therefore help avoid situations where the quality levels of outputted audio data and outputted video data are noticeably different to a user and/or a reduction in quality level of one type of media negatively impacts the perception of quality level of the other type of media. Another technical advantage of the disclosed techniques is that changes in the amount of available network bandwidth do not result in substantial divergencies in the quality levels of the audio data and video data outputted to a user, which improves the overall user experience. These technical advantages provide one or more technical advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a more detailed block diagram of the content server of FIG. 1, according to various embodiments;

FIG. 3 is a more detailed block diagram of the control server of FIG. 1, according to various embodiments; and

FIG. 4 is a more detailed block diagram of the endpoint device of FIG. 1, according to various embodiments;

FIG. 5 illustrates a stream analysis pipeline that resides in the network infrastructure of FIG. 1, according to various embodiments;

FIG. 6A illustrates an exemplary convex hull that defines a joint audio video bitrate ladder, according to various embodiments;

FIG. 6B illustrates how the convex hull analyzer of FIG. 5 generates the convex hull of FIG. 6A, according to various embodiments;

FIG. 7 is a flow diagram of method steps for streaming audiovisual data using a joint audio video bitrate ladder, according to various embodiments; and

FIG. 8 is a flow diagram of method steps for generating a convex hull that defines a joint audio video bitrate ladder, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

A modern streaming service streams audiovisual data associated with media titles to endpoint devices across a network. During streaming, an endpoint device requests audio data from the streaming service at one of several different audio bitrates and outputs audio to a user. Similarly, the endpoint device requests video data from the streaming service at one of several different video bitrates and outputs video to the user. The endpoint device generally selects a particular audio bitrate or a particular video bitrate depending on the currently available network bandwidth.

In some implementations, an endpoint device selects the audio bitrate and the video bitrate independently of one another. In other implementations, an endpoint device implements a fixed allocation of network bandwidth to divide the currently available network bandwidth between streaming the audio data and streaming the video data. In either implementation, endpoint devices can sometimes request audio data and video data with widely differing bitrates. Reconstructed audio or video data that is derived from lower bitrate audio data or lower bitrate video data, respectively, is generally perceived by users as having a lower level of quality, while reconstructed audio data or video data that is derived from higher bitrate audio data or higher bitrate video data, respectively, is generally perceived by users as having a higher level of quality. Because conventional endpoint devices can request audio data and video data with widely differing bitrates, the endpoint devices sometimes output audio data and video data to users with different levels of quality.

One drawback of these conventional approaches to allocating available network bandwidth is that outputting audio data and video data to users with different levels of quality generally leads to a poor user experience, because users typically expect the quality of the audio data and video data associated with any given media title to be relatively consistent with one another throughout the course of a streaming session. Consequently, users can become dissatisfied with the overall streaming experience when the quality of the outputted audio data and video data diverge substantially from one another. Another drawback is that approaches that implement a fixed allocation of bandwidth between streaming audio data and streaming video data cannot efficiently redistribute available bandwidth between streaming audio data and streaming video data during a streaming session. Consequently, under some circumstances, a certain portion of available bandwidth can remain unused. Further, changes in the available network bandwidth can oftentimes cause divergences in the quality levels of outputted audio data and outputted video data which, as described above, can lead to overall poor user experiences.

To address these issues, a stream analysis pipeline is configured to generate a joint audio video bitrate ladder for a given media title that includes specific combinations of audio bitrates and video bitrates that provide superior overall quality per bit compared to other combinations of audio bitrates and video bitrates. The stream analysis pipeline includes a combination analyzer and a convex hull analyzer. The combination analyzer determines the available audio bitrates associated with different streams of audio data associated with the media title. The combination analyzer also determines the available video bitrates associated with different streams of video data associated with the media title. The combination analyzer then generates different combinations of audio bitrates and video bitrates. For any given combination of an audio bitrate and a video bitrate, the combination analyzer generates a joint quality metric. The joint quality metric is a function of an audio quality metric derived from a stream of audio data associated with the media title that is encoded at the audio bitrate, and a video quality metric derived from a stream of video data associated with the media title that is encoded at the video bitrate.

The convex hull analyzer then generates a set of data points based on the set of combinations of audio bitrates and video bitrates and the corresponding joint quality metrics. For any given combination of audio bitrate and video bitrate, the convex hull generator generates a data point that includes the total bitrate associated with the combination and the corresponding joint quality metric. The convex hull generator then evaluates the set of data points to generate a convex hull that borders the set of data points. The convex hull includes a subset of data points that maximize the joint quality metric relative to the total bitrate. The convex hull generator generates the convex hull starting with an initial data point associated with the lowest audio bitrate and the lowest video bitrate. The convex hull generator then identifies additional data points having increased audio bitrate, increased video bitrate, or both increased audio bitrate and increased video bitrate. The convex hull generator then computes slope values between the initial data point and the additional data points. The convex hull generator includes in the convex hull the initial data point and an additional data point that has the greatest slope value relative to the initial data point. This additional data point provides the greatest increase in joint quality relative to the increase in total bitrate. The convex hull generator repeats this process with data points having progressively greater audio bitrate and/or video bitrate until each combination of audio bitrate and video bitrate have been processed. The subset of data points included in the convex hull represent a bitrate ladder that can subsequently be used by an endpoint device to stream audiovisual data.

At least one technical advantage of the disclosed techniques relative to the prior art is that the disclosed techniques enable endpoint devices to select combinations of audio bitrate and video bitrate that maximize a joint quality metric per bit of available bandwidth. Accordingly, for a given level of available network bandwidth, the disclosed techniques enable a given endpoint device to output audio and video to users with similar levels of quality and/or levels of quality that, in combination, maximize an overall quality of experience as measured by the joint quality metric. The disclosed techniques therefore help avoid situations where the quality levels of outputted audio data and outputted video data are noticeably different to a user and/or a reduction in quality level of one type of media negatively impacts the perception of quality level of the other type of media. Another technical advantage of the disclosed techniques is that changes in the amount of available network bandwidth do not result in substantial divergencies in the quality levels of the audio data and video data outputted to a user, which improves the overall user experience. These technical advantages provide one or more technical advancements over prior art approaches.

### System Overview

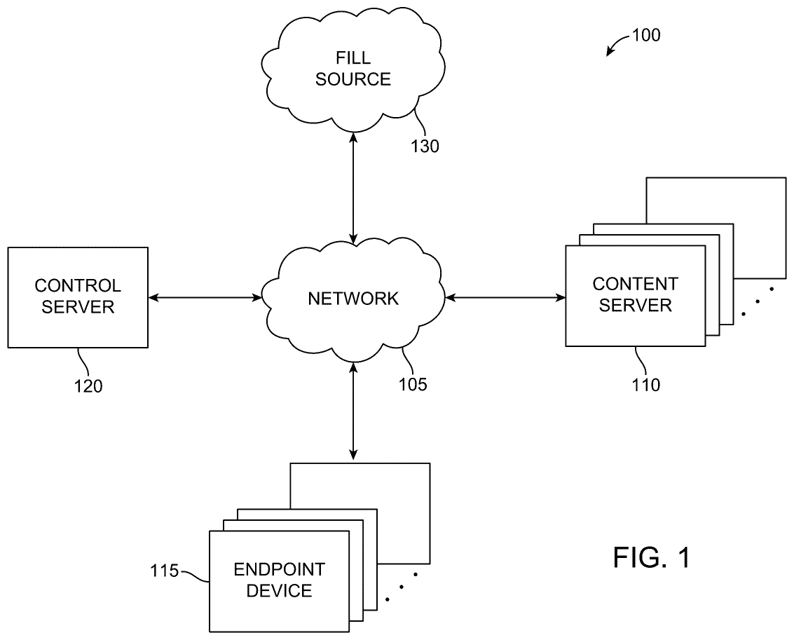

FIG. 1 illustrates a network infrastructure 100 used to distribute content to content servers 110 and endpoint devices 115, according to various embodiments. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, a database, and a server application configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

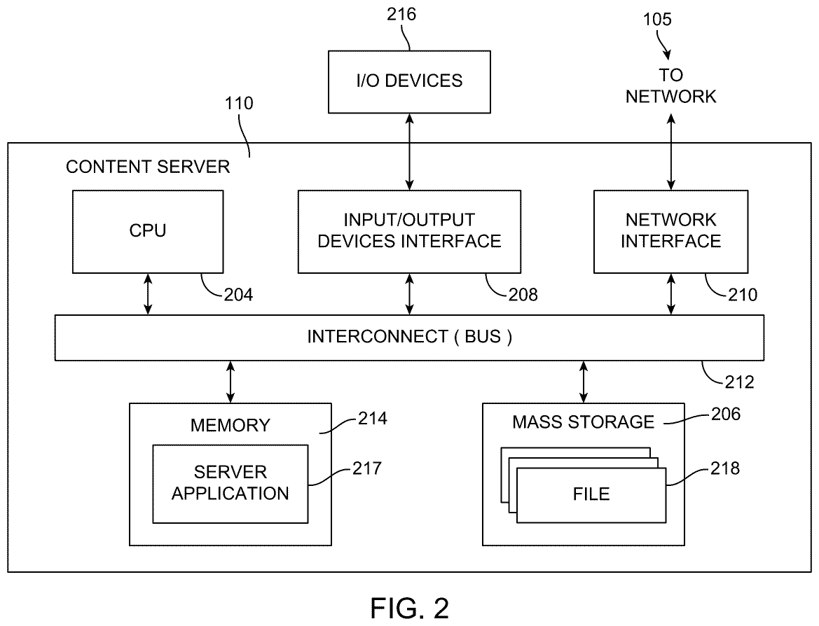

FIG. 2 is a block diagram of a content server 110 that may be implemented in conjunction with the network infrastructure 100 of FIG. 1, according to various embodiments. As shown, the content server 110 includes, without limitation, a central processing unit (CPU) 204, a mass storage 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the mass storage 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The mass storage 206 may include one or more hard disk drives, solid state storage devices, or similar storage devices. The mass storage 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the mass storage 206 and transmits the file 218 to an endpoint device 115 or a content server 110 via the network 105.

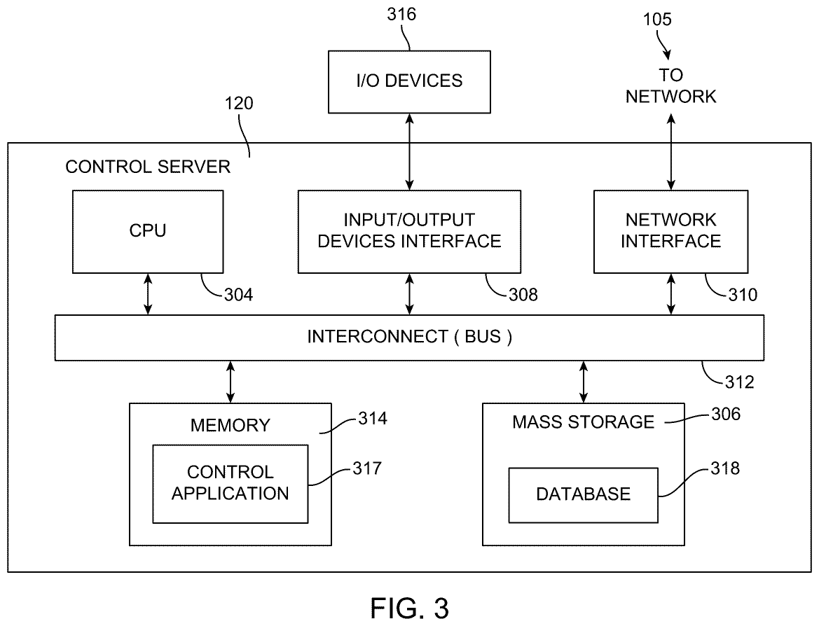

FIG. 3 is a block diagram of a control server 120 that may be implemented in conjunction with the network infrastructure 100 of FIG. 1, according to various embodiments. As shown, the control server 120 includes, without limitation, a central processing unit (CPU) 304, a mass storage 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the mass storage 306. The interconnect 312 is configured to facilitate transmission of data between the CPU 304, the mass storage 306, I/O devices interface 308, the network interface 310, and the system memory 314. The I/O devices interface 308 is configured to transmit input data and output data between the I/O devices 316 and the CPU 304 via the interconnect 312. The mass storage 306 may include one or more hard disk drives, solid state storage devices, and the like. The mass storage 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

Referring generally to FIGS. 1-3, in various embodiments, the system 100 is configured to implement an encoding pipeline (also referred to as an “encoder”) to compress audiovisual content associated with media titles prior to streaming to endpoint device(s) 115. For example, and without limitation, the control server 120 of FIGS. 1 and 3 could implement an encoding pipeline via control application 317 that compresses files 218 prior to transmission to an endpoint device 115. Alternatively, and without limitation, files stored in fill source 130 could be compressed, via an encoding pipeline within system 100, prior to storage.

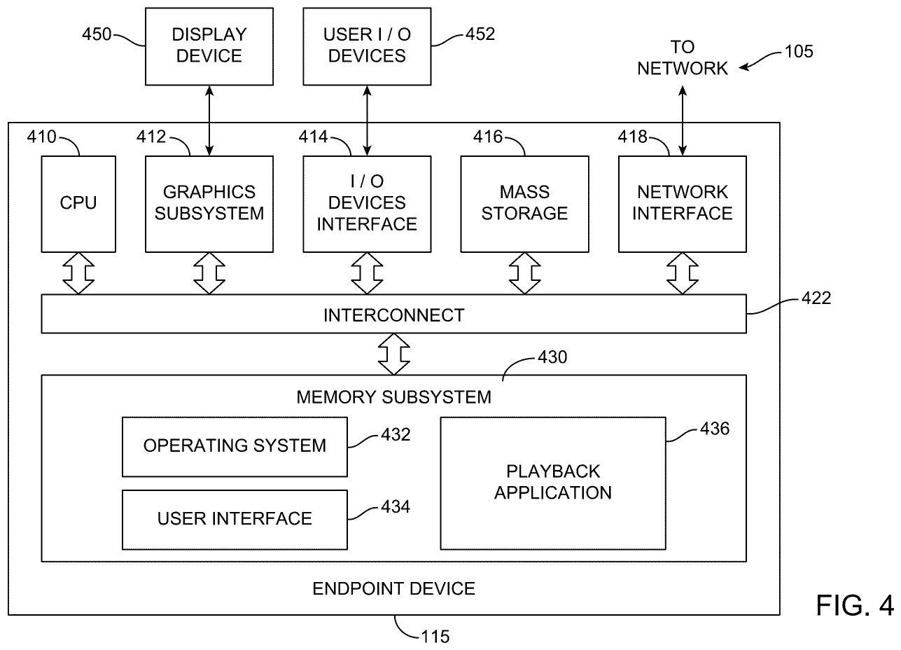

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 115. Persons skilled in the art will recognize the various operating systems and user interfaces that are well-known in the art and suitable for incorporation into the endpoint device 115.

In some embodiments, the playback application 436 is configured to request and receive content from the content server 110 via the network interface 418. Further, the playback application 436 is configured to interpret the content and present the content via display device 450 and/or user I/O devices 452. In one embodiment, the playback application 436 may include a decoding pipeline that decodes compressed content prior to display via display device.

### Joint Audio Video Stream Selection

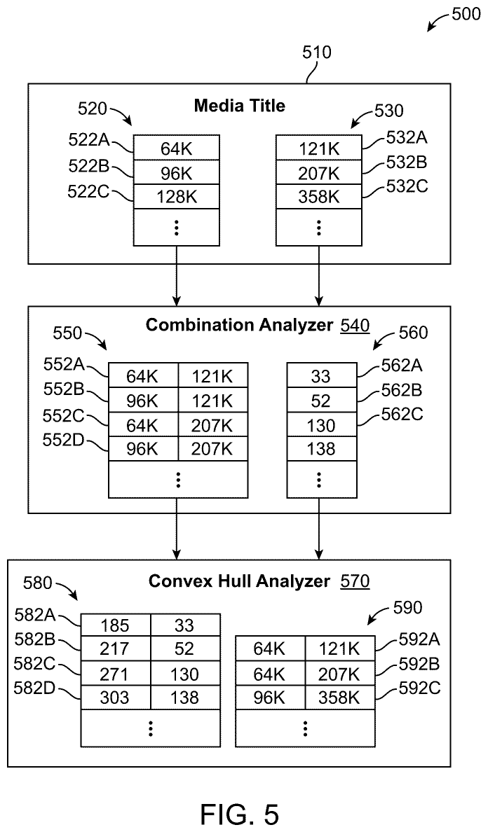

FIG. 5 illustrates a stream analysis pipeline that resides in the network infrastructure of FIG. 1, according to various embodiments. As shown, a stream analysis pipeline 500 is configured to analyze a media title 510 that includes audio data 520 and video data 530. Audio data 520 includes different audio streams 522 that are encoded at different bitrates. Audio data 520 can include any technically feasible number of audio streams 522 encoded at any technically feasible bitrate. In the exemplary audio data shown, audio stream 522A is encoded at 64 k, audio stream 522B is encoded at 96 k, and audio stream 522C is encoded at 128 k, without limitation. In one embodiment, audio streams 522 may form a portion of an audio bitrate ladder. Similar to audio data 520, video data 530 includes different video streams 532 that are encoded at different bitrates. Video data 530 can include any technically feasible number of video streams 532 encoded at any technically feasible bitrates. In the exemplary video data shown, video stream 532A is encoded at 121 k, video stream 532B is encoded at 207 k, and video stream 532C is encoded at 358 k, without limitation. In one embodiment, video streams 532 form a portion of a video bitrate ladder.

As also shown, stream analysis pipeline 500 includes a combination analyzer 540 and a convex hull analyzer 570. Combination analyzer 540 is configured to analyze audio data 520 and video data 530 to generate bitrate combination data 550. Bitrate combination data 550 generally includes different combinations of the bitrates associated with audio streams 522 and the bitrates associated with video streams 532. In the exemplary bitrate combination data shown, a bitrate combination 552A includes a 64 k bitrate derived from audio stream 522A and a 121 k bitrate derived from video stream 532A, a bitrate combination 522B includes a 96 k bitrate derived from audio stream 522B and the 121 k bitrate derived from video stream 532A, a bitrate combination 522C includes the 64 k bitrate derived from audio stream 522A and a 207 k bitrate derived from video stream 532B, and a bitrate combination 522D includes the 96 k bitrate derived from audio stream 522B and the 207 k bitrate derived from video stream 532B, without limitation.

In one embodiment, combination analyzer 540 may generate bitrate combination data 550 progressively, starting with a bitrate combination 552 that includes the lowest audio bitrate and the lowest video bitrate, and then generating additional bitrate combinations 552 by increasing only the audio bitrate, increasing only the video bitrate, or increasing both the audio bitrate and the video bitrate. Combination analyzer 540 can increase any given bitrate by any step size, although in various embodiments combination analyzer 540 increases bitrate monotonically by moving to the next highest bitrate in a ranking of bitrates. In other embodiments, combination analyzer 540 generates bitrate combination data by determining all possible combinations of the bitrates associated with audio streams 522 and the bitrates associated with video streams 532.

Combination analyzer 540 is further configured to generate joint quality metric data 560 based on audio data 520, video data 530, and combination data 550. In particular, combination analyzer 540 analyzes the audio stream 522 and the video stream 532 associated with each bitrate combination 552 included in bitrate combination data 550 to generate a corresponding joint quality metric 562 included in joint quality metric data 560. A given joint quality metric 562 represents the combined audio quality and video quality associated with the corresponding audio stream 522 and video stream 532, respectively, and can have any technically feasible value. As a general matter, the joint quality metric is designed to correlate with user-reported opinion scores for overall quality of experience during streaming of audiovisual data. In one embodiment, audio stream 522 and video stream 532 may be analyzed independently during encoding and assigned audio quality metrics and video quality metrics that are included in audio stream 522 and video stream 532, respectively, as metadata.

In the exemplary joint quality metric data shown, without limitation, joint quality metric 562A has a value of 33 that corresponds to bitrate combination 552A and represents the combined audio quality and video quality associated with audio stream 522A and video stream 532A, respectively. Joint quality metric 562B has a value of 52 that corresponds to bitrate combination 552B and represents the combined audio quality and video quality associated with audio stream 522B and video stream 532A, respectively. Joint quality metric 562C has a value of 130 that corresponds to bitrate combination 552A and represents the combined audio quality and video quality associated with audio stream 522A and video stream 532B, respectively. Joint quality metric 562D has a value of 138 that corresponds to bitrate combination 552D and represents the combined audio quality and video quality associated with audio stream 522B and video stream 532B, respectively.

In one embodiment, combination analyzer 540 may generate the joint quality metric 562 for any given bitrate combination 552 by computing a subjective audio quality metric (SMAQ) value for the corresponding audio stream 522 and computing a Video Multi-method Assessment Fusion (VMAF) value for the corresponding video stream 532. Combination analyzer 540 may then combine these metrics to determine the joint quality metric 562 by evaluating Equation 1:

$$log ( JAVQ ) = log ( VMAF ) + {W}^{*} log ( {( SMAQ - 1 )}^{*} C ) \qquad ( 1 )$$

In Equation 1, JAVQ represents the joint quality metric, W is a weight factor that scales the influence of audio quality on the joint quality metric relative to video quality, and C is a constant value. As a general matter, combination analyzer 540 may implement any technically feasible quality metric that evaluates both audio quality and video quality when generating joint quality metrics 562 included in joint quality metric data 560.

Convex hull analyzer 570 is configured to process bitrate combination data 550 and joint quality metric data 560 to generate a set of data points 580. The set of data points 580 includes a different data point 582 for each bitrate combination 552 and corresponding joint quality metric 562. A given data point 582 is an ordered pair of values, where the first value is the total bitrate associated with the corresponding bitrate combination 552, and the second value is the corresponding joint quality metric 562. The total bitrate associated with a given bitrate combination 552 is the sum of the bitrate derived from the relevant audio stream 522 and the bitrate derived from the relevant video stream 532.

In the exemplary data points shown, data point 582A includes values (185, 33), where 185 is the sum of bitrates 64 k and 121 k included in bitrate combination 552A and 33 is the corresponding joint quality metric 562A, data point 582B includes values (217, 52), where 217 is the sum of bitrates 96 k and 121 k included in bitrate combination 552B and 52 is the corresponding joint quality metric 562B, data point 582C includes values (271, 130), where 271 is the sum of bitrates 64 k and 207 k included in bitrate combination 552C and 130 is the corresponding joint quality metric 562C, and data point 582D includes values (303, 138), where 303 is the sum of bitrates 96 k and 207 k included in bitrate combination 552D and 138 is the corresponding joint quality metric 562D.

Convex hull analyzer 570 analyzes the set of data points 580 and identifies a subset of data points that reside on a convex hull that borders the set of data points 580 in two-dimensional (2D) space. The subset of data points that reside on the convex hull maximize an increase in joint quality metric per increase in bitrate compared to other data points that do not reside on the convex hull. In other words, the subset of data points that reside on the convex hull optimize incremental quality per bit. Convex hull analyzer 580 generates joint audio video bitrate ladder 590 that includes specific bitrate pairs associated with the identified subset of data points 582 residing along the convex hull. In the exemplary joint audio video bitrate ladder shown, without limitation, bitrate pair 592A includes bitrates 64 k and 121 k corresponding to audio stream 522A and video stream 532A, respectively, bitrate pair 592B includes bitrates 64 k and 207 k corresponding to audio stream 522A and video stream 532B, respectively, and bitrate pair 592C includes bitrates 96 k and 358 k corresponding to audio stream 522B and video stream 532C, respectively.

Joint audio video bitrate ladder 590 can be used by an endpoint device 115 to select bitrates for streaming audio data 520 and video data 530 associated with media title 510. When implementing joint audio video bitrate ladder 590 in this manner, the endpoint device 115 outputs audio data and video data with relatively consistent quality and optimal overall quality per bit, thereby enhancing user experience. Further, when the amount of available network bandwidth changes, the endpoint device can select different bitrates for streaming audio data 520 and video data 530 that still provide a consistent level of quality and optimal overall quality per bit.

In various embodiments, the different components of stream analysis pipeline 500 may be distributed across the network infrastructure 100 in any technically feasible fashion. In one embodiment, any given instance of an endpoint device 115 may implement combination analyzer 540 and convex hull analyzer 570 to generate a joint audio video bitrate ladder 590 specifically suited for that endpoint device 115. Persons skilled in the art will understand that implementing certain components of stream analysis pipeline 500 within endpoint devices 115 allows any of the operations described herein to leverage device capability information associated with those endpoint devices 115 when generating a joint audio video bitrate ladder 590. Further, in some embodiments, a given endpoint device 115 or any other component of network infrastructure may filter audio streams 522 and/or video streams 532 during streaming based on a given joint audio video bitrate ladder 590. Persons skilled in the art will understand that this filtering can also be distributed across any components of the network infrastructure 100 in any technically feasible fashion.

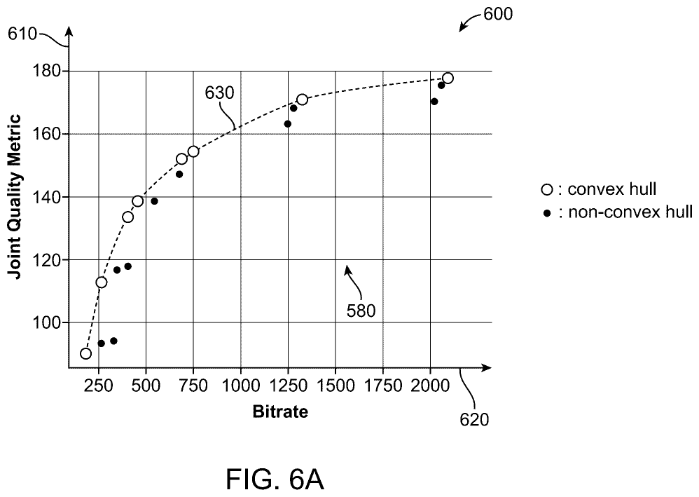

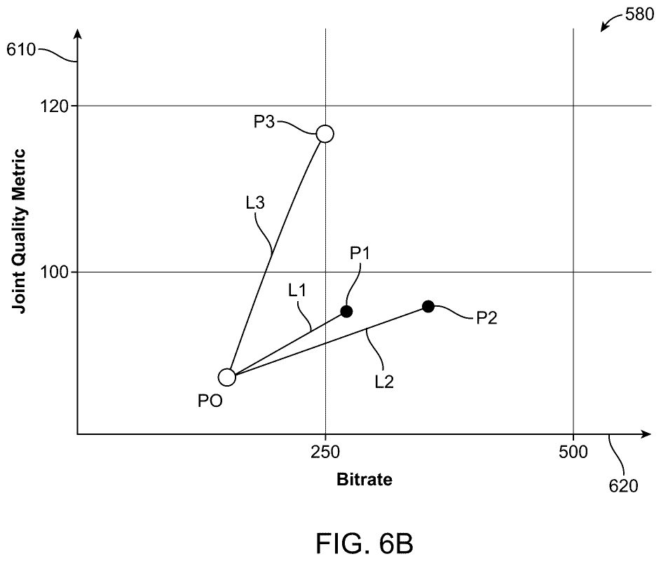

Convex hull analyzer 570 can implement any technically feasible approach to identifying the subset of data points 582 that reside on the convex hull. In one embodiment, convex hull analyzer 570 may implement the technique described below in conjunction with FIGS. 6A-6B.

FIG. 6A illustrates an exemplary convex hull that defines a joint audio video bitrate ladder, according to various embodiments. As shown, a plot 600 includes a joint quality metric axis 610, a bitrate axis 620, and the set of data points 580. As described above in conjunction with FIG. 5, a given data point 582 is an ordered pair that includes a total bitrate and a joint quality metric value. The plot 600 displays joint quality as a function of bitrate for the set of data points 580. Convex hull analyzer 570 analyzes the set of data points 580 to construct convex hull 630. In doing so, convex hull analyzer 570 starts at the data point having the least total bitrate. This data point is included in convex hull 630 by default. Convex hull analyzer 570 then identifies a subsequent data point that maximizes an increase in joint quality compared to an increase in bitrate relative to other data points. Convex hull analyzer 570 includes the identified data point in the convex hull. Then convex hull analyzer 570 repeats this process, starting from the previously identified data point. Convex hull analyzer 570 includes data points that reside on convex hull 630 in joint audio video bitrate ladder 590. Convex hull analyzer 570 identifies data points that maximize the increase in joint quality compared to the increase in bitrate using a technique described in greater detail below in conjunction with FIG. 6B.

FIG. 6B illustrates how the convex hull analyzer of FIG. 5 generates the convex hull of FIG. 6A, according to various embodiments. As shown, a data point P0 resides proximate to three other data points, P1, P2, and P3. Data point P0 is associated with a bitrate combination 552 that corresponds to an audio bitrate and a video bitrate that, in turn, correspond to an audio stream 522 and a video stream 532, respectively. Data points P1, P2, and P3 have an increased audio bitrate, an increased video bitrate, or both an increased audio bitrate and an increased video bitrate relative to data point P1. Convex hull analyzer 570 is configured to compute slope values between data points P0 and P1, P0 and P2, and P0 and P3 along lines L1, L2, and L3, respectively. Convex hull analyzer 570 then determines the greatest slope value along lines L1, L2, and L3. In the example shown, without limitation, the slope value of line L3 is greatest compared to the slope values of lines L1 and L2. Convex hull analyzer 570 therefore determines that data point P3 should be included in convex hull 630. Convex hull analyzer 570 repeats this process, starting from data point P3, with another set of data points (not shown here) that have increased audio bitrate, increased video bit rate, or increased audio bitrate and increased video bitrate, thereby progressively generating convex hull 630.

Referring generally to FIGS. 5 and 6A-6B, the techniques described herein allow the stream analyzer pipeline 500 to generate a joint audio video bitrate ladder 590 for various media titles. These techniques enable endpoint devices 115 to more effectively stream audio data 520 and video data 530 associated with those media titles 510 at consistent levels of quality. Further, when network conditions change and the amount of available network bandwidth increases or decreases, endpoint devices 115 can select a different audio bitrate and video bitrate from joint audio bitrate ladder 590 without causing the audio quality and the video quality to diverge significantly from one another.

In operation, endpoint devices 115 can implement joint audio video bitrate ladder 590 to select an audio bitrate and a video bitrate based on an amount of available bandwidth. For example, a given endpoint device 115 could select bitrate pair 592A when network bandwidth is limited. The endpoint device 115 would then request blocks of audio data that are derived from audio stream 522A that have an audio bitrate of 64 k, and, similarly, request blocks of video data that are derived from video stream 532A that have a video bitrate of 121 k. Subsequently, when network bandwidth is more plentiful, the endpoint device 115 could request blocks of audio data that are derived from audio stream 522B that have an audio bitrate of 96 k, and, similarly, request blocks of video data that are derived from video stream 532C that have a video bitrate of 358 k.

Endpoint devices 115 can select different bitrate pairs 592 from joint audio video bitrate ladder 590 under various circumstances, thereby moving up and down the various levels of joint audio video bitrate ladder 590. In some embodiments, a given endpoint device 115 may select a bitrate pair 592 when a previous request completes or is near completion and a new request is to be issued. For example, and without limitation, the endpoint device 115 could determine that a request for a block of audio data is near completion, and then select a bitrate pair 592 from joint audio video bitrate ladder 590 based on current network conditions. The selected bitrate pair 592 could then be used to request additional blocks at the relevant bitrate specified in that pair. The choice of whether a block of audio is requested or a block of video is requested depends on various factors, including buffer levels.

In various embodiments, audio blocks and video blocks may be requested at different times and potentially have different durations, potentially causing boundaries between sequential audio blocks and sequential video blocks to not necessarily be aligned. This misalignment may cause, in some instances, a given block of one media type (audio or video) to be output according to one bitrate combination, while another block of a different media type (video or audio) may be output according to a different bitrate combination. For example, and without limitation, suppose an endpoint device 115 selects a new bitrate pair and outputs a video block associated with that bitrate pair while already outputting an audio block associated with a previously selected bitrate pair. In this exemplary situation, the video block and audio block would not necessarily be associated with a bitrate pair included in the joint audio bitrate ladder, and could potentially be associated with a sub-optimal bitrate pair not found on the convex hull. Under typical network conditions, however, selections of bitrate pairs are made far less frequently than new blocks of either media type are requested, thereby minimizing periods of time where non-optimal combinations of bitrates are used. Various techniques can be used to address the situations described herein, as described in greater detail below.

In one embodiment, a given endpoint device 115 may select a bitrate pair 592 each time a request is sent, regardless of whether the request is for a block of audio or a block of video. In this case, the selection of a bitrate pair 592 specifies two bitrates, but only one bitrate is used. In another embodiment, a given endpoint device 115 may select a bitrate pair 592 each time a request for a specific media type is issued (either audio or video). When a request is issued for the other type of media, the most recent selection of a bitrate pair 592 may be used. In yet another embodiment, a given endpoint device 115 may select a bitrate pair 592 periodically, e.g. once per second, and then use the most recent selection when a new request is to be issued. In yet another embodiment, a given endpoint device 115 may select a bitrate pair 592 before each request, unless a selection was made recently, e.g. within one second, in which case the previous selection may be used. In yet another embodiment, a given endpoint device 115 may conditionally select a new bitrate pair 592 before each request or use a previously selected bitrate pair 592 based on network conditions and/or the elapsed time since a previous request was completed. As a general matter, any given endpoint device 115 may implement any technically feasible approach to selecting audio bitrate and/or video bitrate when requesting audio data and/or video data, respectively, based on joint audio video bitrate ladder 590.

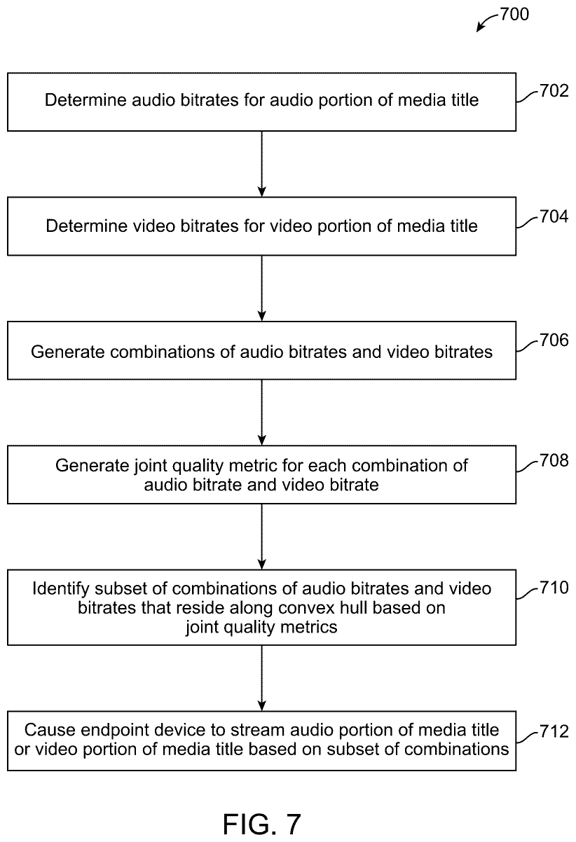

FIG. 7 is a flow diagram of method steps for streaming audiovisual data using a joint audio video bitrate ladder, according to various embodiments. Although the method steps are described in conjunction with the systems of FIGS. 1-6B, persons skilled in the art will understand that any system configured to perform the method steps, in any order, is within the scope of the present invention. Furthermore, persons skilled in the art will understand specific ways that any of the operations described herein may be optimized.

As shown, a method 700 begins at step 702, where combination analyzer 540 determines audio bitrates for an audio portion of a media title. The audio portion of the media title includes different audio streams that are encoded at different bitrates. The various audio streams may form a portion of an audio bitrate ladder, in some embodiments. At step 704, combination analyzer 540 determines video bitrates for a video portion of the media title. The video portion of the media title includes different video streams that are encoded at different bitrates. The various video streams may form a portion of a video bitrate ladder, in some embodiments.

At step 706, combination analyzer 540 generates various combinations of audio bitrates and video bitrates based on the audio bitrates and video bitrates determined at steps 702 and 704, respectively. In one embodiment, combination analyzer 540 may generate combinations of audio bitrates and video bitrates progressively, starting with a bitrate combination that includes the lowest audio bitrate and the lowest video bitrate, and then generating additional bitrate combinations by increasing only the audio bitrate, increasing only the video bitrate, or increasing both the audio bitrate and the video bitrate. Combination analyzer 540 can increase any given bitrate by any step size, although in various embodiments combination analyzer 540 increases bitrate monotonically by moving to the next highest bitrate in a ranking of bitrates. In one embodiment, combination analyzer 540 may adaptively implement a larger step size when the joint quality metric between sequential bitrate pairs falls beneath a threshold.

At step 708, combination analyzer 540 generates joint quality metrics corresponding to the combinations of audio bitrate and video bitrate generated at step 706. Combination analyzer 540 analyzes the audio stream and the video stream associated with each bitrate combination to generate a corresponding joint quality metric. A given joint quality metric represents the combined audio quality and video quality associated with the corresponding audio stream and video stream, respectively. In one embodiment, combination analyzer 540 may generate the joint quality metric 562 for any given bitrate combination 552 by computing a SMAQ value for the corresponding audio stream and computing a VMAF value for the corresponding video stream and then computing a weighted sum of the SMAQ value and the VMAF value.

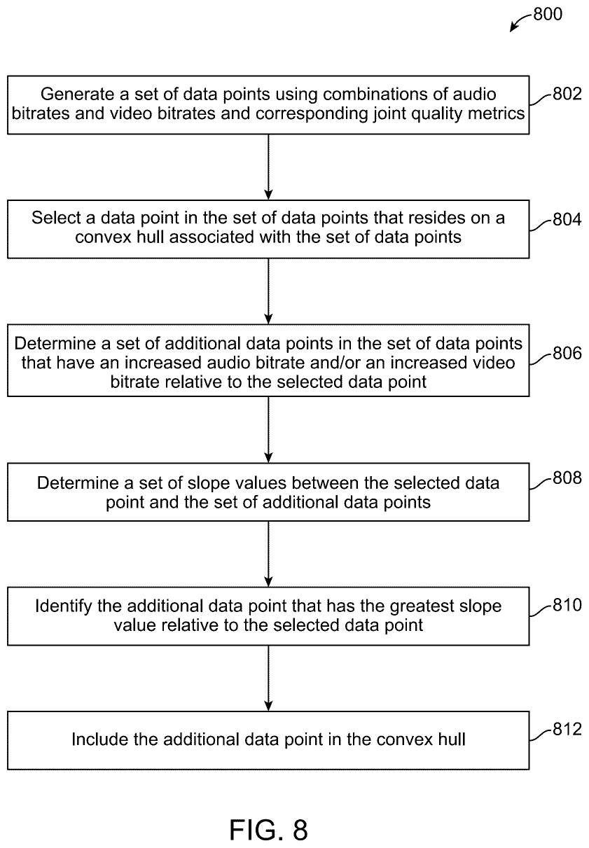

At step 710, convex hull analyzer 570 identifies a subset of combinations of audio bitrates and video bitrates that reside along a convex hull based on the joint quality metrics generated at step 708. Convex hull analyzer 570 generates a set of data points that includes a different data point for each bitrate combination and corresponding joint quality metric. Convex hull analyzer 570 analyzes the set of data points 580 and identifies a subset of data points that border the set of data points 580 in 2D space along the convex hull. The subset of data points that reside on the convex hull maximize an increase in joint quality metric per increase in bitrate compared to other data points that do not reside on the convex hull. A technique for generating the convex hull is described in greater detail below in conjunction with FIG. 8. The subset of combinations of audio bitrates and video bitrates that reside along the convex hull define a joint audio video bitrate ladder that can be used by endpoint devices 115 to stream audio data and video data associated with media titles.

At step 712, control server 120 causes an endpoint device 115 to stream the audio portion of the media title and/or the video portion of the media title based on the subset of combinations of bitrates that define the joint audio video bitrate ladder. In practice, the endpoint device can implement the joint audio video bitrate ladder to select an audio bitrate and/or a video bitrate based on an amount of available bandwidth, and then adaptively select a new audio bitrate and/or video bitrate when the amount of available network bandwidth changes. These techniques enable endpoint devices to more effectively stream audio data and video data associated with media titles at consistent levels of audio and video quality that do not diverge significantly from one another and optimize quality per bit.

FIG. 8 is a flow diagram of method steps for generating a convex hull that defines a joint audio video bitrate ladder, according to various embodiments. Although the method steps are described in conjunction with the systems of FIGS. 1-7, persons skilled in the art will understand that any system configured to perform the method steps, in any order, is within the scope of the present invention.

As shown, a method 800 begins at step, where convex hull analyzer 570 generates a set of data points using combinations of audio bitrates and video bitrates and corresponding joint quality metrics. Each data point is an ordered pair of values, where the first value is the total bitrate associated with the corresponding bitrate combination and the second value is the corresponding joint quality metric. Convex hull analyzer 570 is configured to project the set of data points onto a two-dimensional plane, such as plot 600 shown in FIG. 6B.

At step 804, convex hull analyzer 570 selects a data point in the set of data points that resides on a convex hull associated with the set of data points. By default, the data point corresponding to the lowest total bitrate resides on the convex hull. Accordingly, during an initial pass, at step 804 convex hull analyzer 570 selects the data point having the lowest total bitrate. In the example shown in FIG. 6B, convex hull analyzer 570 could select data point P0, for example and without limitation.

At step 806, convex hull analyzer 570 determines a set of additional data points in the set of data points that have an increased audio bitrate and/or an increased video bitrate relative to the selected data point. In one embodiment, the set of additional data points may include any data point in the set of data points having the next highest bitrate in a ranking of either the audio bitrates or the video bitrates. This constraint can improve the processing time needed to generate the convex hull because convex hull analyzer 570 need only consider additional data points with monotonically increasing audio bitrates and/or video bitrates relative to the data point selected at step 804.

At step 808, convex hull analyzer 570 determined a set of slope values between the selected data point and the set of additional data points. For example, and without limitation, convex hull analyzer 570 can perform the geometric analysis set forth in conjunction with FIG. 6B in order to generate slope values for line segments connecting the selected data point with each additional data point. Persons skilled in the art will understand that slope values can also be calculated between data points without first needing to plot those data points on a two-dimensional plane.

At step 810, convex hull analyzer 570 identifies the additional data point that has the greatest slope value relative to the selected data point. The identified data point provides the greatest incremental increase in joint quality metric compared to the increase in bitrate relative to the selected data point. The identified data point therefore forms a portion of the convex hull that borders the set of data points on a two-dimensional plane.

At step 812, convex hull analyzer 570 includes the additional data point in the convex hull. Convex hull analyzer 570 can repeat the method 800 for subsequent data points in order to progressively generate the convex hull. In so doing, convex hull analyzer 570 can select, at step 804, data points that have already been included in the convex hull via previous passes of the method 800. In this manner, convex hull analyzer 570 iteratively identifies data points on the convex hull and associated bitrate combinations that should be included in the joint audio video bitrate ladder.

In sum, a stream analysis pipeline is configured to generate a joint audio video bitrate ladder for a given media title that includes specific combinations of audio bitrates and video bitrates that provide superior quality per bit compared to other combinations of audio bitrates and video bitrates. The stream analysis pipeline includes a combination analyzer and a convex hull analyzer. The combination analyzer determines the available audio bitrates associated with different streams of audio data associated with the media title. The combination analyzer also determines the available video bitrates associated with different streams of video data associated with the media title. The combination analyzer then generates different combinations of audio bitrates and video bitrates. For any given combination of an audio bitrate and a video bitrate, the combination analyzer generates a joint quality metric. The joint quality metric is a weighted combination of an audio quality metric derived from a stream of audio data associated with the media title that is encoded at the audio bitrate, and a video quality metric derived from a stream of video data associated with the media title that is encoded at the video bitrate.

The convex hull analyzer then generates a set of data points based on the set of combinations of audio bitrates and video bitrates and the corresponding joint quality metrics. For any given combination of audio bitrate and video bitrate, the convex hull generator generates a data point that includes the total bitrate associated with the combination and the corresponding joint quality metric. The convex hull generator then evaluates the set of data points to generate a convex hull that borders the set of data points. The convex hull includes a subset of data points that maximize the joint quality metric relative to the total bitrate. The convex hull generator generates the convex hull starting with an initial data point associated with the lowest audio bitrate and the lowest video bitrate. The convex hull generator then identifies additional data points having increased audio bitrate, increased video bitrate, or both increased audio bitrate and increased video bitrate. The convex hull generator then computes the slope value between the initial data point and the additional data points. The convex hull generator includes in the convex hull the initial data point and an additional data point that has the greatest slope relative to the initial data point. This additional data point provides the greatest increase in joint quality relative to the increase in total bitrate. The convex hull generator repeats this process with data points having progressively greater audio bitrate and/or video bitrate until all combinations of audio bitrate and video bitrate have been processed. The subset of data points included in the convex hull represent a bitrate ladder that can subsequently be used by an endpoint device to stream audiovisual data.

At least one technical advantage of the disclosed techniques relative to the prior art is that the disclosed techniques enable endpoint devices to select combinations of audio bitrate and video bitrate that maximize a joint quality metric per bit of available bandwidth. Accordingly, for a given level of available network bandwidth, the disclosed techniques enable a given endpoint device to output audio and video to users with similar levels of quality and/or levels of quality that, in combination, maximize an overall quality of experience as measured by the joint quality metric. The disclosed techniques therefore help avoid situations where the quality levels of outputted audio data and outputted video data are noticeably different to a user and/or a reduction in quality level of one type of media negatively impacts the perception of quality level of the other type of media. Another technical advantage of the disclosed techniques is that changes in the amount of available network bandwidth do not result in substantial divergencies in the quality levels of the audio data and video data outputted to a user, which improves the overall user experience. These technical advantages provide one or more technical advancements over prior art approaches.

1. Various embodiments include a computer-implemented method for streaming audiovisual data associated with media titles, the method comprising generating a set of bitrate combinations associated with a media title, generating a set of quality metrics corresponding to the set of bitrate combinations based on an audio portion of the media title and a video portion of the media title, identifying a subset of bitrate combinations included in the set of bitrate combinations that reside along a convex hull that is associated with the set of bitrate combinations and the set of quality metrics, and causing an endpoint device to stream at least one of the audio portion of the media title or the video portion of the media title based on the subset of bitrate combinations.

2. The computer-implemented method of clause 1, wherein each bitrate combination included in the set of bitrate combinations includes an audio bitrate associated with the audio portion of the media title and a video bitrate associated with the video portion of the media title.

3. The computer-implemented method of any of clauses 1-2, wherein each quality metric included in the set of quality metrics corresponds to a different bitrate combination included in the set of bitrate combinations.

4. The computer-implemented method of any of clauses 1-3, wherein generating the set of bitrate combinations comprises pairing a first audio bitrate associated with the audio portion of the media title with a first video bitrate associated with the video portion of the media title to generate a first bitrate combination included in the set of bitrate combinations, and increasing at least one of the first audio bitrate or the first video bitrate to generate a second bitrate combination included in the set of bitrate combinations.

5. The computer-implemented method of any of clauses 1-4, wherein generating the set of bitrate combinations comprises pairing a first audio bitrate associated with the audio portion of the media title with a first video bitrate associated with the video portion of the media title to generate a first bitrate combination included in the set of bitrate combinations, pairing the first audio bitrate with a second video bitrate associated with the video portion of the media title to generate a second bitrate combination included in the set of bitrate combinations, pairing a second audio bitrate associated with the audio portion of the media title with the first video bitrate to generate a third bitrate combination included in the set of bitrate combinations, and pairing the second audio bitrate with the second video bitrate to generate a fourth bitrate combination included in the set of bitrate combinations.

6. The computer-implemented method of any of clauses 1-5, wherein a first quality metric included in the set of quality metrics is generated by generating a first audio quality metric for a first audio stream that is included in the audio portion of the media title and encoded using a first audio bitrate, generating a first video quality metric for a first video stream that is included in the video portion of the media title and encoded using a first video bitrate, and computing a weighted sum of the first audio quality metric and the first video quality metric.

7. The computer-implemented method of any of clauses 1-6, wherein a first quality metric included in the set of quality metrics is generated by computing a subjective audio quality metric for a first audio stream included in the audio portion of the media title, computing a video multi-method assessment fusion value for a first video stream included in the video portion of the media title, and combining the subjective audio quality metric and the video multi-method assessment fusion value.

8. The computer-implemented method of any of clauses 1-7, wherein identifying the subset of bitrate combinations comprises generating a set of data points based on the set of bitrate combinations and the set of quality metrics, projecting the set of data points onto a two-dimensional plane, and determining a subset of data points included in the set of data points that form a border along the set of data points on the two-dimensional plane, wherein the subset of bitrate combinations corresponds to the subset of data points.

9. The computer-implemented method of any of clauses 1-8, wherein identifying the subset of bitrate combinations comprises generating a set of data points based on the set of bitrate combinations and the set of quality metrics, generating a first slope value between a first data point included in the set of data points and a second data point included in the set of data points, and determining that a bitrate combination associated with the second data point should be included in the subset of bitrate combinations based on the first slope value.

10. The computer-implemented method of any of clauses 1-9, wherein identifying the subset of bitrate combinations comprises generating a first data point based on a first bitrate combination included in the set of bitrate combinations and a first quality metric included in the set of quality metrics, generating a second data point based on a second bitrate combination included in the set of bitrate combinations and a second quality metric included in the set of quality metrics, generating a third data point based on a third bitrate combination included in the set of bitrate combinations and a third quality metric included in the set of quality metrics, generating a first slope value between the first data point and the second data point, generating a second slope value between the first data point and the third data point, determining that the first slope value exceeds the second slope value, and in response, determining that the second bitrate combination should be included in the subset of bitrate combinations.

11. Various embodiments include one or more non-transitory computer-readable media including instructions that, when executed by one or more processors, cause the one or more processors to stream audiovisual data associated with media titles by performing the steps of generating a set of bitrate combinations associated with a media title, generating a set of quality metrics corresponding to the set of bitrate combinations based on an audio portion of the media title and a video portion of the media title, identifying a subset of bitrate combinations included in the set of bitrate combinations that reside along a convex hull that is associated with the set of bitrate combinations and the set of quality metrics, and causing an endpoint device to stream at least one of the audio portion of the media title or the video portion of the media title based on the subset of bitrate combinations.

12. The non-transitory computer-readable media of clause 11, wherein each bitrate combination included in the set of bitrate combinations includes an audio bitrate associated with the audio portion of the media title and a video bitrate associated with the video portion of the media title.

13. The non-transitory computer-readable media of any of clauses 11-12, wherein each quality metric included in the set of quality metrics corresponds to a different bitrate combination included in the set of bitrate combinations.

14. The non-transitory computer-readable media of any of clauses 11-13, wherein the step of generating the set of bitrate combinations comprises pairing a first audio bitrate associated with the audio portion of the media title with a first video bitrate associated with the video portion of the media title to generate a first bitrate combination included in the set of bitrate combinations, and increasing at least one of the first audio bitrate or the first video bitrate to generate a second bitrate combination included in the set of bitrate combinations.

15. The non-transitory computer-readable media of any of clauses 11-14, wherein a first quality metric included in the set of quality metrics is generated by generating a first audio quality metric for a first audio stream that is included in the audio portion of the media title and encoded using a first audio bitrate, generating a first video quality metric for a first video stream that is included in the video portion of the media title and encoded using a first video bitrate, and computing a weighted sum of the first audio quality metric and the first video quality metric.

16. The non-transitory computer-readable media of any of clauses 11-15, wherein a first quality metric included in the set of quality metrics is generated by computing a subjective audio quality metric for a first audio stream included in the audio portion of the media title, computing a video multi-method assessment fusion value for a first video stream included in the video portion of the media title, and combining the subjective audio quality metric and the video multi-method assessment fusion value.

17. The non-transitory computer-readable media of any of clauses 11-16, wherein the step of identifying the subset of bitrate combinations comprises generating a set of data points based on the set of bitrate combinations and the set of quality metrics, projecting the set of data points onto a two-dimensional plane, and determining a subset of data points included in the set of data points that form a border along the set of data points on the two-dimensional plane, wherein the subset of bitrate combinations corresponds to the subset of data points.

18. The non-transitory computer-readable media of any of clauses 11-17, wherein the step of causing the endpoint device to stream at least one of the audio portion of the media title or the video portion of the media title comprises causing the endpoint device to select a first bitrate combination included in the subset of bitrate combinations, wherein the first bitrate combination includes an first audio bitrate and a first video bitrate, and causing the endpoint device to stream at least one of an audio stream that is included in the audio portion of the media title and encoded using the first audio bitrate or a video stream that is included in the video portion of the media title and encoded using the first video bitrate.

19. The non-transitory computer-readable media of any of clauses 11-18, wherein the step of causing the endpoint device to stream at least one of the audio portion of the media title or the video portion of the media title comprises causing the endpoint device to select a first bitrate combination included in the subset of bitrate combinations based on at least one of an amount of available network bandwidth or a network request status associated with the audio portion of the media title or the video portion of the media title, and causing the endpoint device to stream at least one of an audio stream that is included in the audio portion of the media title or a video stream that is included in the video portion of the media title based on the first bitrate combination.

20. Various embodiments include a system comprising one or more memories storing instructions, and one or more processors coupled to the one or more memories that, when executing the instructions, perform the steps of generating a set of bitrate combinations associated with a media title, generating a set of quality metrics corresponding to the set of bitrate combinations based on an audio portion of the media title and a video portion of the media title, identifying a subset of bitrate combinations included in the set of bitrate combinations that reside along a convex hull that is associated with the set of bitrate combinations and the set of quality metrics, and causing an endpoint device to stream at least one of the audio portion of the media title or the video portion of the media title based on the subset of bitrate combinations

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for streaming audiovisual data associated with media titles, the method comprising:
generating a set of bitrate combinations associated with a media title;
generating a set of quality metrics corresponding to the set of bitrate combinations based on an audio portion of the media title and a video portion of the media title;
identifying a subset of bitrate combinations included in the set of bitrate combinations that reside along a convex hull that is associated with the set of bitrate combinations and the set of quality metrics; and
causing an endpoint device to stream at least one of the audio portion of the media title or the video portion of the media title based on the subset of bitrate combinations.

2. The computer-implemented method of claim 1, wherein each bitrate combination included in the set of bitrate combinations includes an audio bitrate associated with the audio portion of the media title and a video bitrate associated with the video portion of the media title.

3. The computer-implemented method of claim 1, wherein each quality metric included in the set of quality metrics corresponds to a different bitrate combination included in the set of bitrate combinations.

4. The computer-implemented method of claim 1, wherein generating the set of bitrate combinations comprises:
pairing a first audio bitrate associated with the audio portion of the media title with a first video bitrate associated with the video portion of the media title to generate a first bitrate combination included in the set of bitrate combinations; and
increasing at least one of the first audio bitrate or the first video bitrate to generate a second bitrate combination included in the set of bitrate combinations.

5. The computer-implemented method of claim 1, wherein generating the set of bitrate combinations comprises:
pairing a first audio bitrate associated with the audio portion of the media title with a first video bitrate associated with the video portion of the media title to generate a first bitrate combination included in the set of bitrate combinations;
pairing the first audio bitrate with a second video bitrate associated with the video portion of the media title to generate a second bitrate combination included in the set of bitrate combinations;
pairing a second audio bitrate associated with the audio portion of the media title with the first video bitrate to generate a third bitrate combination included in the set of bitrate combinations; and
pairing the second audio bitrate with the second video bitrate to generate a fourth bitrate combination included in the set of bitrate combinations.

6. The computer-implemented method of claim 1, wherein a first quality metric included in the set of quality metrics is generated by:
generating a first audio quality metric for a first audio stream that is included in the audio portion of the media title and encoded using a first audio bitrate;
generating a first video quality metric for a first video stream that is included in the video portion of the media title and encoded using a first video bitrate; and
computing a weighted sum of the first audio quality metric and the first video quality metric.

7. The computer-implemented method of claim 1, wherein a first quality metric included in the set of quality metrics is generated by:
computing a subjective audio quality metric for a first audio stream included in the audio portion of the media title;
computing a video multi-method assessment fusion value for a first video stream included in the video portion of the media title; and
combining the subjective audio quality metric and the video multi-method assessment fusion value.

8. The computer-implemented method of claim 1, wherein identifying the subset of bitrate combinations comprises:
generating a set of data points based on the set of bitrate combinations and the set of quality metrics;
projecting the set of data points onto a two-dimensional plane; and
determining a subset of data points included in the set of data points that form a border along the set of data points on the two-dimensional plane, wherein the subset of bitrate combinations corresponds to the subset of data points.

9. The computer-implemented method of claim 1, wherein identifying the subset of bitrate combinations comprises:
generating a set of data points based on the set of bitrate combinations and the set of quality metrics;
generating a first slope value between a first data point included in the set of data points and a second data point included in the set of data points; and
determining that a bitrate combination associated with the second data point should be included in the subset of bitrate combinations based on the first slope value.

10. The computer-implemented method of claim 1, wherein identifying the subset of bitrate combinations comprises:
generating a first data point based on a first bitrate combination included in the set of bitrate combinations and a first quality metric included in the set of quality metrics;
generating a second data point based on a second bitrate combination included in the set of bitrate combinations and a second quality metric included in the set of quality metrics;
generating a third data point based on a third bitrate combination included in the set of bitrate combinations and a third quality metric included in the set of quality metrics;
generating a first slope value between the first data point and the second data point;
generating a second slope value between the first data point and the third data point;
determining that the first slope value exceeds the second slope value; and
in response, determining that the second bitrate combination should be included in the subset of bitrate combinations.

11. One or more non-transitory computer-readable media including instructions that, when executed by one or more processors, cause the one or more processors to stream audiovisual data associated with media titles by performing the steps of:
generating a set of bitrate combinations associated with a media title;
generating a set of quality metrics corresponding to the set of bitrate combinations based on an audio portion of the media title and a video portion of the media title;
identifying a subset of bitrate combinations included in the set of bitrate combinations that reside along a convex hull that is associated with the set of bitrate combinations and the set of quality metrics; and
causing an endpoint device to stream at least one of the audio portion of the media title or the video portion of the media title based on the subset of bitrate combinations.

12. The non-transitory computer-readable media of claim 11, wherein each bitrate combination included in the set of bitrate combinations includes an audio bitrate associated with the audio portion of the media title and a video bitrate associated with the video portion of the media title.

13. The non-transitory computer-readable media of claim 11, wherein each quality metric included in the set of quality metrics corresponds to a different bitrate combination included in the set of bitrate combinations.

14. The non-transitory computer-readable media of claim 11, wherein the step of generating the set of bitrate combinations comprises:
pairing a first audio bitrate associated with the audio portion of the media title with a first video bitrate associated with the video portion of the media title to generate a first bitrate combination included in the set of bitrate combinations; and
increasing at least one of the first audio bitrate or the first video bitrate to generate a second bitrate combination included in the set of bitrate combinations.

15. The non-transitory computer-readable media of claim 11, wherein a first quality metric included in the set of quality metrics is generated by:
generating a first audio quality metric for a first audio stream that is included in the audio portion of the media title and encoded using a first audio bitrate;
generating a first video quality metric for a first video stream that is included in the video portion of the media title and encoded using a first video bitrate; and
computing a weighted sum of the first audio quality metric and the first video quality metric.

16. The non-transitory computer-readable media of claim 11, wherein a first quality metric included in the set of quality metrics is generated by:
computing a subjective audio quality metric for a first audio stream included in the audio portion of the media title;
computing a video multi-method assessment fusion value for a first video stream included in the video portion of the media title; and
combining the subjective audio quality metric and the video multi-method assessment fusion value.

17. The non-transitory computer-readable media of claim 11, wherein the step of identifying the subset of bitrate combinations comprises:
generating a set of data points based on the set of bitrate combinations and the set of quality metrics;
projecting the set of data points onto a two-dimensional plane; and
determining a subset of data points included in the set of data points that form a border along the set of data points on the two-dimensional plane, wherein the subset of bitrate combinations corresponds to the subset of data points.

18. The non-transitory computer-readable media of claim 11, wherein the step of causing the endpoint device to stream at least one of the audio portion of the media title or the video portion of the media title comprises:
causing the endpoint device to select a first bitrate combination included in the subset of bitrate combinations, wherein the first bitrate combination includes an first audio bitrate and a first video bitrate; and
causing the endpoint device to stream at least one of an audio stream that is included in the audio portion of the media title and encoded using the first audio bitrate or a video stream that is included in the video portion of the media title and encoded using the first video bitrate.

19. The non-transitory computer-readable media of claim 11, wherein the step of causing the endpoint device to stream at least one of the audio portion of the media title or the video portion of the media title comprises:
causing the endpoint device to select a first bitrate combination included in the subset of bitrate combinations based on at least one of an amount of available network bandwidth or a network request status associated with the audio portion of the media title or the video portion of the media title; and
causing the endpoint device to stream at least one of an audio stream that is included in the audio portion of the media title or a video stream that is included in the video portion of the media title based on the first bitrate combination.

20. A system comprising:
one or more memories storing instructions; and
one or more processors coupled to the one or more memories that, when executing the instructions, perform the steps of:
generating a set of bitrate combinations associated with a media title,
generating a set of quality metrics corresponding to the set of bitrate combinations based on an audio portion of the media title and a video portion of the media title,
identifying a subset of bitrate combinations included in the set of bitrate combinations that reside along a convex hull that is associated with the set of bitrate combinations and the set of quality metrics, and
causing an endpoint device to stream at least one of the audio portion of the media title or the video portion of the media title based on the subset of bitrate combinations.
